(19) United States
(12) Patent Application Publication
(10) Pub. No.: US 2011/0088814 A1
(43) Pub. Date: Apr. 21, 2011

(54) Beveller

(75) Inventor: Reijo SALOVAARA, Nastola (FI)

(73) Assignee: RAUTE OYJ, Nastola (FI)

(21) Appl. No.: 12/906,459

(22) Filed: Oct. 18, 2010

(30) Foreign Application Priority Data
Oct. 20, 2009 (FI) 20096077

(51) Int. Cl. B27G 13/00

(52) U.S. Cl. 144/218

(57) ABSTRACT

The invention concerns a beveller for providing an edge bevel for thin wood veneers and the like, comprising a milling cutter equipped with cutting knives projecting from the circumferential surface and rotating about a shaft subjected to a rotating force. The milling cutter is divided in its axial direction into at least two sections separated by a space, and at least one of the spaces is equipped with a presser directed to the surface to be cut.

The present invention concerns a beveller for forming a bevel edge to a sheet-like piece, specifically to a wood veneer.

Various plate constructions, like plywood, are manufactured from dried wood veneer. The manufacturing process includes splicing of the veneer sheets edge to edge, and in order to provide a tight edge-to-edge joint, the edges to be spliced are bevelled for example to an angle of 10° with respect to the sheet plane. Bevelling is usually performed by using a circular saw having a position in accordance with the bevelling angle with respect to the plane of the veneer. Problems are caused by the wavy buckling of the veneer, resulting in thickness variations in the joint area, ranging from 1 to 1,5 mm. This kind of a joint does not provide a proper base for film coating. The prior art bevelling of wood veneer is applicable only to bevelling of the veneer edge across the grain. Bevelling in the grain direction results in a broken edge bevel.

These problems were significantly reduced by means of a beveller according to the present invention. The beveller of the invention comprises a milling cutter equipped with cutting knives projecting from a circumferential surface, said milling cutter rotating about a shaft rotated by a rotating force. This milling cutter is characterized in that the milling cutter is divided in the axial direction into at least two sections separated by a space, and that at least one of the spaces is equipped with pressing means pressing the surface to be cut. Additional features of the beveller according to the invention are described in the enclosed dependent claims.

The invention will be described by means of the enclosed drawing, wherein

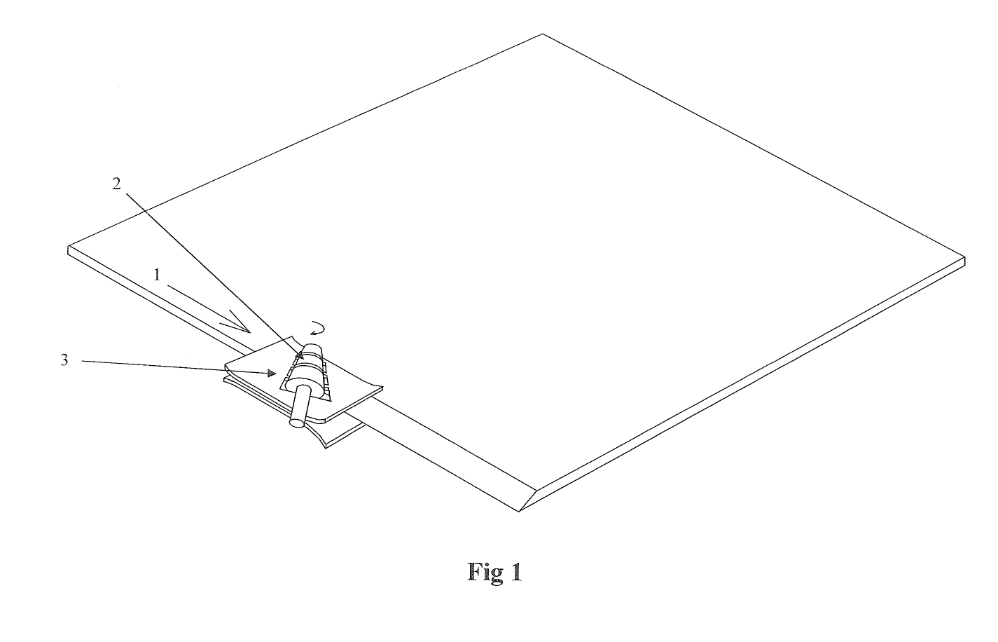

FIG. 1 shows a general illustration of a beveller according to the invention in its operating situation, and

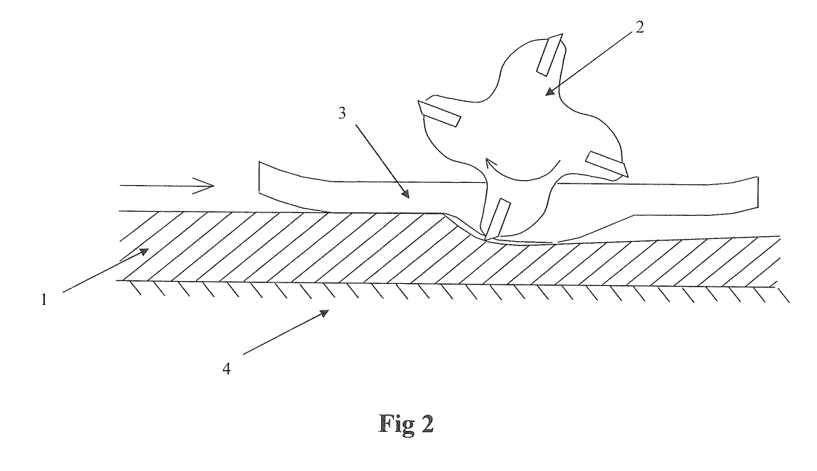

FIG. 2 shows a more detailed illustration of the beveller.

FIG. 1 shows schematically a wood veneer 1, which is subjected to edge bevelling operation. Sheet 1 moves in the direction shown by the arrow towards the beveller 2 cutting the bevel. The beveller 2 is illustrated schematically. It comprises a substantially cylindrical milling cutter, as shown, supported by a rotatable shaft. The milling cutter is equipped, as known in the art, with knives proceeding along the circumferential surface substantially in the axial direction of the milling cutter or along a spiral configuration and projecting from the circumferential surface for providing the desired milling effect. According to the basic idea of the invention, the milling cutter is in the axial direction divided into at least two sections separated by a space, wherein a presser 3 is located in the space. The presser evens out the wavy forms of the veneer 1, as a result of which the veneer is in the cutting situation substantially in an even state. Preferably the presser acts against a counter surface 4, whereby the veneer is firmly controllable for the cutting event.

The presser 3 can be a plate construction according to FIG. 1, having apertures for the sections of the milling cutter, said apertures being separated by intermediate neck portions pressing the veneer in the space positions during the cutting. In this kind of an implementation of the presser, the portion of the presser 3 in the immediate vicinity of the milling cutter 2 is formed like a skid, as shown in FIG. 2. For that part, the presser according to the invention can also be implemented having an other kind of a construction, in an extreme case as a pressing ring supported in the space by bearings to the shaft of the milling cutter.

The distance of the presser from the shaft of the milling cutter is smaller than the radial projection of the knives of the milling cutter, the difference corresponding to the intended cutting dept.

The shaft of the milling cutter is positioned in an angle corresponding to the bevel angle with respect to the veneer plane. The positioning must also be in an oblique angle with respect to the proceeding direction of the veneer, so that the adjacent milling cutter sections will cover the cutting areas missing at the spaces.

For implementing the invention, the milling cutter must be divided at least into two sections, preferably to 3 to 4 sections for providing the bevel cutting of the veneer intended for the plywood production.

1. A beveller for providing an edge bevel for thin wood veneers and the like, comprising a milling cutter equipped with cutting knives projecting from the circumferential surface and rotating about a shaft subjected to a rotating force, wherein the milling cutter is divided in its axial direction into at least two sections separated by a space, and at least one of the spaces is equipped with a presser directed to the surface to be cut.

2. A beveller according to claim 1, wherein the presser is operable against a counter surface.

3. A beveller according to claim 2, wherein the counter surface is movable in the feeding direction of the veneer.

4. A beveller according to claim 1, wherein the presser is a sheet construction having apertures for each milling cutter section, said apertures being separated by necks.
